(19) United States
(12) Patent Application Publication
(10) Pub. No.: US 2023/0300444 A1
(43) Pub. Date: Sep. 21, 2023

(54) IMAGE CAPTURING SYSTEM AND METHOD FOR ADJUSTING FOCUS

(71) Applicant: SONIC STAR GLOBAL LIMITED, TORTOLA (VG)

(72) Inventor: YI-PIN CHANG, HSINCHU CITY (TW)

(21) Appl. No.: 17/698,581

(22) Filed: Mar. 18, 2022

(51) Int. Cl. H04N 5/232; G06V 20/70; G06F 3/16; G06T 7/20; G06V 10/70; G10L 17/06; G10L 17/22; G10L 17/18

(52) U.S. Cl. CPC H04N 5/23218; H04N 5/232935; G06V 20/70; H04N 5/232127; G06F 3/167; H04N 5/232125; G06T 7/20; G06V 10/70; H04N 5/232939; G10L 17/06; G10L 17/22; G10L 17/18

(57) ABSTRACT

The present application discloses an image capturing system and a method for adjusting focus. The image capturing system includes an image-sensing module, a plurality of processors, a display panel, and an audio acquisition module. A first processor is configured to detect objects in a preview image sensed by the image-sensing module and attach identification labels to the objects detected. The display panel shows the preview image along with the identification labels. The audio acquisition module converts an analog signal of a user's voice into digital voice data. One of the processors is configured to parse the digital voice data into user intent data. A second processor is configured to select a target from the detected objects in the preview image according to the user intent data and the identification labels of the detected objects, and control the image-sensing module to perform a focusing operation with respect to the target.

### TECHNICAL FIELD

The present disclosure relates to an image capturing system, and more particularly, to an image capturing system using voice-based focus control.

### DISCUSSION OF THE BACKGROUND

Autofocus is a common function for current digital cameras in electronic devices. For example, an application processor of a mobile electronic device may achieve the autofocus function by dividing a preview image into several blocks and selecting a block having most textures or details to be a focus region. However, if the block selected by the electronic device does not meet a user's expectation, the user needs to manually select the focus region on his/her own. Therefore, a touch focus function has been proposed. The touch focus function allows the user to touch a block on a display touch panel of the electronic device that he/she would like to focus on, and the application processor then adjusts the focus region accordingly.

However, the touch focus function requires complex and unstable manual operations. For example, the user may have to hold the electronic device, touch a block to be focused on, and take a picture all within a short period of time. Since the block may contain a number of objects, it can be difficult to know exactly which object the user wants to focus on, thus causing inaccuracy and ambiguity. Furthermore, when the user touches the display touch panel of the electronic device, such action may shake the electronic device or alter a field of view of a camera. In such case, a region the user touches may no longer be the actual block the user wants to focus on, and consequently a photo taken may not be satisfying. Therefore, finding a convenient means to select the region to focus on with greater accuracy when taking pictures has become an issue to be solved.

### SUMMARY

One embodiment of the present disclosure discloses an image capturing system. The image capturing system comprises an image-sensing module, a plurality of processors, a display panel, and an audio acquisition module. The processors comprise a first processor and a second processor. The first processor is configured to detect a plurality of objects in a preview image sensed by the image-sensing module and attach identification labels to the objects detected. The display panel is configured to display the preview image with the identification labels of the detected objects. The audio acquisition module is configured to convert an analog signal of a user's voice into digital voice data. At least one of the processors is configured to parse the digital voice data into user intent data. The second processor is configured to select a target from the detected objects in the preview image according to the user intent data and the identification labels of the detected objects, and control the image-sensing module to perform a focusing operation with respect to the target.

Another embodiment of the present disclosure discloses a method for adjusting focus. The method comprises sensing, by an image-sensing module, a preview image; detecting a plurality of objects in the preview image; attaching identification labels to the objects detected; displaying the preview image with the identification labels of the detected objects on a display panel; converting, by an audio acquisition module, an analog signal of a user's voice into digital voice data; parsing the digital voice data into user intent data, selecting a target from the detected objects in the preview image according to the user intent data and the identification labels of the detected objects; and controlling the image-sensing module to perform a focusing operation with respect to the target.

Since the image capturing system and the method for adjusting focus provided by the embodiments of the present disclosure allow a user to select a target or a specific subject to be focused by means of voice-based focus control, the user can concentrate on holding and stabilizing the camera or the electronic device while composing a photo without touching the display panel for focusing, thereby simplifying the image-capturing process and avoiding shaking the image capturing system. Furthermore, since the objects in the preview image can be detected and labeled for the user to select from using the proposed voice-based focus control, the focusing operation can be performed with respect to the target directly with greater accuracy.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows an image capturing system according to one embodiment of the present disclosure.

FIG. 2 shows a method for adjusting focus according to one embodiment of the present disclosure.

FIG. 3 shows a preview image according to one embodiment of the present disclosure.

FIG. 4 shows the preview image in FIG. 3 with identification labels of the objects.

FIG. 5 shows an image capturing system according to another embodiment of the present disclosure.

FIG. 6 shows the image-sensing module 110 according to one embodiment of the present disclosure.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

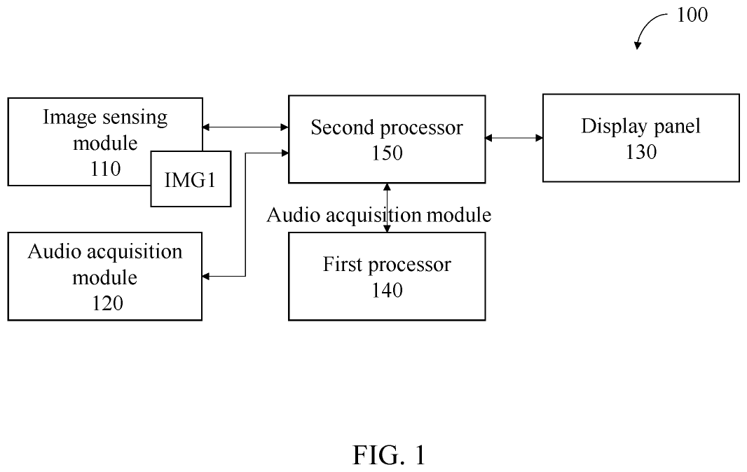

FIG. 1 shows an image capturing system 100 according to one embodiment of the present disclosure. The image capturing system 100 includes an image-sensing module 110, an audio acquisition module 120, a display panel 130, a first processor 140, and a second processor 150. In the present embodiment, the image-sensing module 110 may be used to sense a preview image IMG1 of a desired scene, and the first processor 140 may detect objects in the preview image IMG1 and attach identification labels to the detected objects. The display panel 130 may display the preview image IMG1 and the identification labels of the objects detected by the first processor 140. A user may speak the name or the serial number of a target among the objects detected in the preview image IMG1 according to the identification labels shown on the display panel 130, and the audio acquisition module 120 may convert the analog signal of the user's voice into digital voice data. Subsequently, the image capturing system 100 may parse the digital voice data into user intent data and select the target from the detected objects in the preview image IMG1 according to the user intent data and the identification labels of the detected objects. Once the target is selected, the second processor 150 may control the image-sensing module 110 to perform a focusing operation with respect to the target. In this way, when the image capturing system 100 is operated to take a picture of the desired scene, the target or subject of interest has been chosen and in focus. That is, the image capturing system 100 allows the user to select, by voice input, the target on which the image-sensing module 110 should focus.

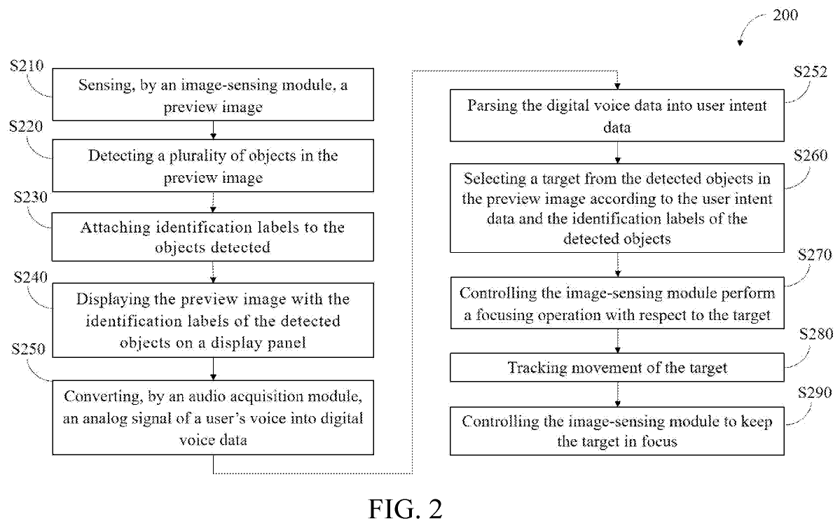

FIG. 2 shows a method 200 for adjusting focus according to one embodiment of the present disclosure. The method 200 includes steps S210 to S290, and can be applied to the image capturing system 100.

In step S210, the image-sensing module 110 may capture the preview image IMG1, and in step S220, the first processor 140 may detect objects in the preview image IMG1. In some embodiments, the first processor 140 may be an artificial intelligence (AI) processor, and the first processor 140 may detect the objects according to a machine learning model, such as a deep learning model utilizing a neuro-network structure. For example, a well-known object detection algorithm, YOLO (You Only Live Once), proposed by Joseph Redmon et al. in 2015, may be adopted. In some embodiments, the first processor 140 may comprise a plurality of processing units, such as neural-network processing units (NPU), for parallel computation so that the speed of object detection based on the neuro network can be accelerated. However, the present disclosure is not limited thereto. In other embodiments, other suitable models for object detection may be adopted, and a structure of the first processor 140 may be adjusted accordingly.

Furthermore, in some embodiments, to improve an accuracy of object detection, the preview image IMG1 captured by the image-sensing module 110 may be subject to image processing to have a better quality. For example, the image capturing system 100 may be incorporated in a mobile device, and the second processor 150 may be an application processor of the mobile device. In such case, the second processor 150 may include an image signal processor (ISP) and may perform image enhancement operations, such as auto white balance (AWB), color correction or noise reduction, on the preview image IMG1 before the first processor 140 detects the objects in the preview image IMG1 so that the first processor 140 can detect the objects with greater accuracy.

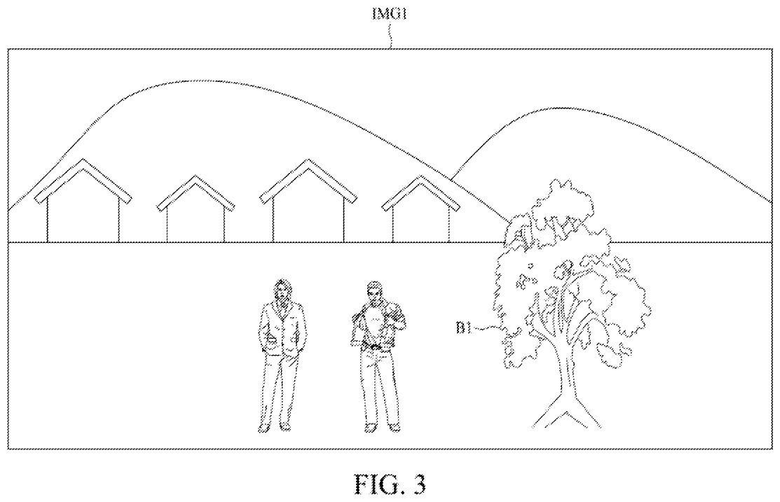

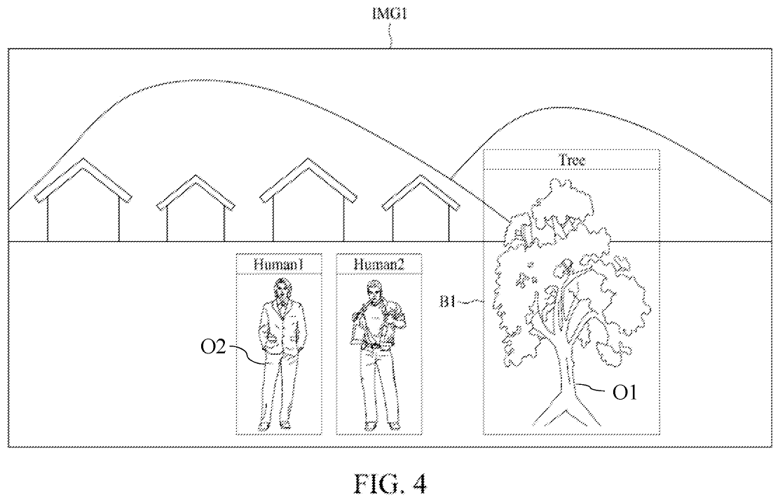

After the objects are detected, the first processor 140 may attach identification labels to the detected objects in step S230, and the display panel 130 may display the preview image IMG1 with the identification labels of the detected objects in step S240. FIG. 3 shows the preview image IMG1 according to one embodiment of the present disclosure, and FIG. 4 shows the preview image IMG1 including the objects detected along with their identification labels.

As shown in FIG. 4, the identification labels of the objects been detected include names of the objects and bounding boxes surrounding the objects. For example, in FIG. 4, a tree in the preview image IMG1 is detected, and an identification label of the tree includes a name “Tree” and a bounding box B1 that surrounds the tree. However, the present disclosure is not limited thereto. In some other embodiments, since there may be a lot of same objects in the preview image IMG1, the identification label of the object may further include a serial number. For example, in FIG. 4, the identification label of a first person may be “Human 1,” and the identification label of a second person may be “Human 2.” Furthermore, in some other embodiments, the names of objects may be omitted, and unique serial numbers may be applied for identifying different objects. That is, a designer may define the identification label according to his/her needs to improve a user experience. In some embodiments, the bounding boxes may be omitted, and the identification labels of objects may include at least one of the serial numbers and names, which allows the user to refer to the target with a unique word or phrase.

In the present embodiment, when the user sees the preview image IMG1 and the identification labels of the objects shown on the display panel 130, the user may select a target from the objects that have been detected by speaking the name and/or the serial number of the target contingent on the content of the object identification labels. Meanwhile, in step S250, the audio acquisition module 120 may take an analog signal of a user's voice and convert the analog signal into digital voice data. In some embodiments, the image capturing system 100 may be incorporated in a mobile device, such as a smart phone or a tablet, and the audio acquisition module 120 may include a microphone that is used for a phone call function.

After the user's voice is converted into digital voice data, the digital voice data may be parsed into the user intend data in step S252. In some embodiments, the user's voice may convey a speech, and the user intend data may be derived by analyzing the content of the user's speech in the digital voice data.

In some embodiments, a speech recognition algorithm may utilize a machine learning model, such as a deep learning model, for parsing the digital voice data. The deep learning model has a multi-layer structure, and may take features extracted from a previous layer and use the features as an input for the next layer. Thus, feature learning will be used to attempt to learn the transformation of the previously learned features at each new layer. Since the deep learning model can be evolved to find crucial features by training, it has been adopted in a variety of types of recognition algorithms in the field of computer science, for example, object recognition algorithms and speech recognition algorithms.

In some embodiments, since the first processor 140 may have a multi-core structure that is suitable for realizing algorithms utilizing machine learning models, the first processor 140 may be utilized to realize the deep learning model for speech recognition to parse the digital voice data into the user intend data in step S252 as well. However, the present disclosure is not limited thereto. In some other embodiments, if the first processor 140 is not suitable for operating the chosen speech-recognizing algorithm, the image capturing system 100 may further include a third processor that is compatible with the chosen speech-recognizing algorithm to perform step S252. In yet some other embodiments, instead of the machine learning-based algorithm, a speech-recognizing algorithm using Gaussian Mixture Models (GMMs) that are based on hidden Markov models (HMMs) may be adopted. In such case, the second processor 150 or another processor suitable for realizing the GMM models may be employed accordingly.

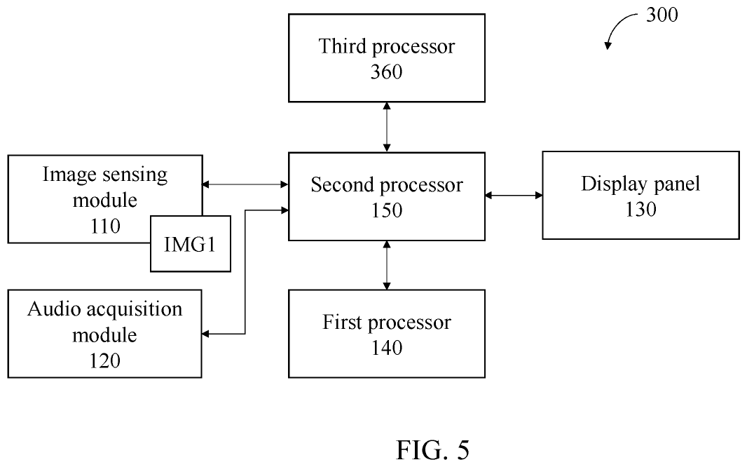

Furthermore, in some embodiments, the speech recognition may be performed by more than one processor. FIG. 5 shows an image capturing system 300 according to one embodiment of the present disclosure. The image capturing system 300 and the image capturing system 100 have similar structures and can both be used to perform the method 200. However, as shown in FIG. 5, the image capturing system 300 further includes a third processor 360. In the embodiment of FIG. 5, the second processor 150 may perform audio signal processing, such as noise reduction, to enhance the quality of the analog signal and/or the digital voice data, and the third processor 360 may perform the speech recognition algorithm for parsing the digital voice data into the user intend data.

In some embodiments, to reduce power consumption, the audio acquisition module 120 may only be enabled when a speak-to-focus function is activated. Otherwise, if the autofocus function already meets the user's requirement or the user chooses to adjust the focus by some other means, the speak-to-focus function may not be activated, and the audio acquisition module 120 can be disabled accordingly.

After the digital voice data is parsed into the user intend data in step S252, the second processor 150 may select the target in the preview image IMG1 according to the user intend data and the identification labels of the detected objects in step S260. For example, the second processor 150 may decide the target when the user intent data includes a data segment that matches the identification label of the target. For example, if the second processor 150 determines that the user intend data includes a data segment matching the identification label of an object O1 in the preview image IMG1, such as the name “Tree” of the object O1, then the object O1 will be selected as the target.

Alternatively, if the second processor 150 determines that the user intend data includes a data segment matching the object name “Human 1” of an object O2 in the preview image IMG1, then the object O2 will be selected as the target. That is, the image capturing system 100 allows the user to select the target to be focused on by saying the object name and/or the serial number listed in the object identification labels. Therefore, when taking pictures, users can concentrate on holding and stabilizing the camera or the electronic device while composing a picture without touching the display panel 130 for focusing, thereby not only simplifying an image-capturing process but avoiding shaking the image capturing system 100. Furthermore, since the objects in the preview image IMG1 can be detected and labeled for the user to select from, the selection operation based on voice input is more intuitive, and the focusing operation can be performed with respect to the target with greater accuracy.

In some embodiments, to confirm the user's selection, the second processor 120 may change a visual appearance of an identification label of the object that the user selects via voice input. For example, the second processor 120 may select a candidate object from the objects in the preview image IMG1 when the user intend data includes a data segment that matches the identification label of the candidate object, and may change a visual appearance of the identification label of the candidate object so as to visually distinguish the candidate object from the reset of the objects in the preview image IMG1. For example, in some embodiments, the second processor 120 may change the color of the bounding box of the candidate object. Therefore, the user is able to check if the candidate object is his/her target. In some embodiments, if the candidate object is not that the user intends to focus on, the user may say the object name and/or the object serial number of the desired object again, and steps S240 to S260 may be performed repeatedly until the target is selected and confirmed.

In addition, to confirm that the candidate object selected by the image capturing system 100 is the correct target, the user may say a predetermined confirm command, for example but not limited to “yes” or “okay.” In such case, the audio acquisition module 120 may receive the analog signal of the user's voice, and convert the analog signal into digital voice data so that the speech recognition can be performed. When the user intent data is recognized that there is a command segment matching the confirm command, the image capturing system 100 then confirms that the candidate object is the target to be focused.

Also, to allow the user to be visually aware of the object been picked via voice input, the second processor 120 may change a visual appearance of the identification label of the target once the target is selected through the above described steps. For example, in some embodiments, the second processor 120 may change the color of the bounding box B1 of the object O1 that has been selected as the target. As a result, the user can distinguish the selected object from the other objects according to colors of the identification labels. Since the image capturing system 100 can display the objects in a scene with their identification labels, the user may select the target from the labeled objects shown on the display panel 130 directly by saying the name and/or the serial number of the target. Therefore, any ambiguity caused by selecting adjacent objects via hand touch can be avoided.

In some embodiments, the user may take pictures in a noisy environment or an environment full of people. In such cases, noises or voices of other people may interfere the image capturing system 100 when performing the speak-to-focus function. For example, if a person next to the user says the name of a certain object detected in the preview image IMG1, the image capturing system 100 may accidentally select this object as the target. To avoid such case, before step S260, the method 200 may further check the user's identity according to the characteristics of the user's voice, such as his/her voiceprint. Consequently, in step S260, the target will only be decided if the identity of the user is verified as valid and the user intent data includes a data segment that matches the identification label of the target.

Once the target is selected, the second processor 150 may control the image-sensing module 110 to perform a focusing operation with respect to the target in step S270 for subsequent capturing operations.

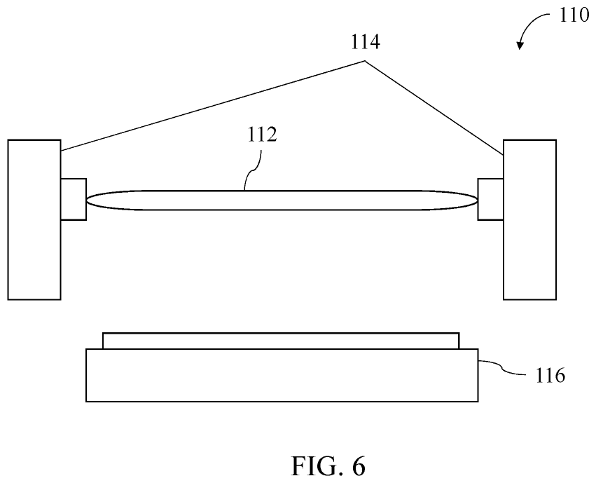

FIG. 6 shows the image-sensing module 110 according to one embodiment of the present disclosure. As shown in FIG. 6, the image-sensing module 110 may include a lens 112, a lens motor 114, and an image sensor 116. The lens 112 can project images on the image sensor 116, and the lens motor 114 can adjust a position of the lens 112 so as to adjust a focus of the image-sensing module 110. In such case, the second processor 150 may control the lens motor 114 to adjust the position of the lens so that the target selected in step S260 can be seen clearly in the image sensed by the image sensor 116. As a result, the user may take a picture of the desired scene with the image-sensing module 110 focused on the target after step S270.

In the present embodiment, after the focus of the image-sensing module 110 is adjusted with respect to the target, the second processor 150 may further track the movement of the target in step S280, and control the image-sensing module 110 to keep the target in focus in step S290. For example, the first processor 140 and/or other processor(s) may extract features of the target in the preview image IMG1 and locate or track the moving target by feature mapping. In some embodiments, any known focus tracking technique that is suitable may be adopted in step S280. Consequently, after step S280 and/or S290, when the user commands the image capturing system 100 to capture an image, the image-sensing module 110 captures the image while focusing on the target.

In summary, the image capturing system and the method for adjusting focus provided by the embodiments of the present disclosure allow the user to select the target on which the image-sensing module should focus by saying the name and/or the serial number of the target shown on the display panel. Users can concentrate on holding and stabilizing the camera or the electronic device while composing a photo without touching the display panel for focusing, thereby not only simplifying an image-capturing process but avoiding shaking the image capturing system. Furthermore, since the objects in the preview image can be detected and labeled for the user to select from using voice-based focus control, the focusing operation can be performed with respect to the target directly with greater accuracy.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image capturing system, comprising:
an image-sensing module;
a plurality of processors comprising a first processor and a second processor, wherein the first processor is configured to detect a plurality of objects in a preview image sensed by the image-sensing module and attach identification labels to the objects detected;
a display panel configured to display the preview image with the identification labels of the detected objects; and
an audio acquisition module configured to convert an analog signal of a user's voice into digital voice data;
wherein:
at least one of the processors is configured to parse the digital voice data into user intent data; and
the second processor is configured to select a target from the detected objects in the preview image according to the user intent data and the identification labels of the detected objects, and control the image-sensing module to perform a focusing operation with respect to the target.

2. The image capturing system of claim 1, wherein the first processor is an artificial intelligence (AI) processor comprising a plurality of processing units, and the first processor is configured to detect the objects according to a machine learning model.

3. The image capturing system of claim 1, wherein the audio acquisition module is enabled when a speak-to-focus function is activated so as to allow the user to select the target by voice input, and the audio acquisition module is disabled when the speak-to-focus function is not activated.

4. The image capturing system of claim 1, wherein the second processor is further configured to track movement of the target and control the image-sensing module to keep the target in focus.

5. The image capturing system of claim 1, wherein the second processor decides the target when the user intent data includes a data segment that matches an identification label of the target.

6. The image capturing system of claim 1, wherein at least one of the first processor, the second processor, and a third processor is configured to recognize an identity of the user based on characteristics of the user's voice, and the second processor decides the target when the identity of the user is verified as valid and the user intent data includes a data segment that matches an identification label of the target.

7. The image capturing system of claim 1, wherein the identification labels attached to the objects comprise at least one of serial numbers of the objects and names of the objects.

8. The image capturing system of claim 1, wherein the second processor is further configured to select a candidate object from the detected objects when the user intent data includes a data segment that matches an identification label of a detected object, and change a visual appearance of the identification label of the candidate object so as to visually distinguish the candidate object from rest of the objects in the preview image.

9. The image capturing system of claim 8, wherein the second processor is further configured to confirm that the candidate object is the target to be focused when the user intent data includes a command segment that matches a confirm command.

10. The image capturing system of claim 1, wherein the second processor is further configured to change a visual appearance of an identification label of the target after the target is selected.

11. A method for adjusting focus, comprising:
sensing, by an image-sensing module, a preview image;
detecting a plurality of objects in the preview image;
attaching identification labels to the objects detected;
displaying the preview image with the identification labels of the detected objects on a display panel;
converting, by an audio acquisition module, an analog signal of a user's voice into digital voice data;
parsing the digital voice data into user intent data;
selecting a target from the detected objects in the preview image according to the user intent data and the identification labels of the detected objects; and
controlling the image-sensing module to perform a focusing operation with respect to the target.

12. The method of claim 11, wherein the act of detecting objects in the preview image comprises detecting the objects in the preview image according to a machine learning model.

13. The method of claim 11, further comprising:
enabling the audio acquisition module when a speak-to-focus function is activated so as to allow the user to select the target by voice input; and
disabling the audio acquisition module when the speak-to-focus function is not activated.

14. The method of claim 11, further comprising:
tracking movement of the target; and
controlling the image-sensing module to keep the target in focus.

15. The method of claim 11, wherein the act of selecting a target from the detected objects comprises deciding the target when the user intent data includes a data segment that matches an identification label of the target.

16. The method of claim 11, further comprising:
recognizing an identity of the user based on characteristics of the user's voice;
wherein the act of selecting a target from the detected objects comprises deciding the target when the identity of the user is verified as valid and the user intent data includes a data segment that matches an identification label of the target.

17. The method of claim 11, wherein the identification labels attached to the objects comprise at least one of serial numbers of the objects and names of the objects.

18. The method of claim 11, wherein the act of selecting a target from the detected objects comprises:
selecting a candidate object from the detected objects when the user intent data includes a data segment that matches an identification label of a detected object; and
changing a visual appearance of the identification label of the candidate object so as to visually distinguish the candidate object from rest of the objects in the preview image.

19. The method of claim 18, wherein the act of selecting a target from the detected objects further comprises confirming that the candidate object is the target to be focused when the user intent data includes a command segment that matches a confirm command.

20. The method of claim 11, further comprising changing a visual appearance of an identification label of the target after the target is selected.
